(19) United States
(12) Patent Application Publication
(10) Pub. No.: US 2007/0044723 A1
(43) Pub. Date: Mar. 1, 2007

(54) Pet feeding device

(76) Inventor: Tracy Anderbery, Poulsbo, WA (US)

Correspondence Address: HARSHAW RESEARCH INCORPORATED, P O BOX 418, OTTAWA, KS, 66067, US

(21) Appl. No.: 11/507,194

(22) Filed: Aug. 21, 2006

Related U.S. Application Data
(60) Provisional application No. 60/710,720, filed on Aug. 23, 2005.

(51) Int. Cl. A01K 39/00

(52) U.S. Cl. 119/51.02

(57) ABSTRACT

A pet feeding device includes a casing and a feeding drawer that is movable between open and closed positions. A motor is connected to a spool and a cord couples the spool to the drawer so that the drawer may be selectively moved between the open and closed configurations. The cord is stretchable such that it yields if an obstruction, e.g. a pet paw, is caught between the drawer and casing as the drawer moves between open and closed configurations. A pressure sensor may also sense this obstruction and actuate movement of the drawer to the open configuration. The feeding device may include one or more transmitter(s) and sensor(s) for communicating distinctive data for causing the drawer to open or close when a predetermined transmitter is positioned in front of the drawer. The transmitter may be situated on a pet collar.

### CROSS REFERENCE TO RELATED APPLICATION

This non-provisional patent application claims the benefit of provisional application Ser. No. 60/710,720 filed on Aug. 23, 2005.

### BACKGROUND OF THE INVENTION

Many pet owners desire to control the dietary parameters of one or more of their pets. This may entail merely controlling the volume or frequency of the pet's food intake or perhaps the dietary content. This procedure for carefully regulating the feeding practices of a person's pets is made more difficult if one pet physically deprives another pet of the carefully prepared meal. When many pets are feeding simultaneously, it is readily observed that one pet may be urged out of the way by a stronger or more aggressive pet such that the desire for the weaker pet to consume a particular amount or diet of food is hindered.

Various devices have been proposed in the art for closing a drawer of food if a desired pet has been urged out of the way by a more aggressive pet. More particularly, multiple pets may be fitted with collars having radio signaling equipment that automatically opens a drawer of food when the pet is in proximity to the drawer (by sending a respective signal to a receiver) and closes the drawer when the expected signal is no longer within the predetermined proximity. Although assumably effective for their intended purposes, the existing devices fail to eliminate the chance of a pet being hit or pinched by the automatic movement of the door.

Therefore, it would be desirable to have a pet feeding device that operates one or more drawers to open or close when a pet is within a predetermined proximity to a feeding drawer or displaced therefrom, respectively. Further, it would be desirable to have a pet feeding device that senses if a portion of a pet's body is caught in or impacted by the feeding drawer and reverses a movement of the container so as to prevent injury to the pet.

### SUMMARY OF THE INVENTION

As will be described more fully below, the present invention provides pets with the ability to obtain their specific diet at will and without owner supervision. The pet feeding device allows owners of multiple pets to keep track of what pets are eating and how much food is being consumed. The product is especially advantageous for pets with special dietary needs. Food will only be made available to a pre-determined or pre-approved pet and other pets are denied access if they nudge the pre-approved pet out of the way.

A pet feeding device according to the present invention includes a casing having at least one feeding drawer. The drawer includes a holding area, a front wall, and a cord connection point. The drawer is movable between a first (“closed”) configuration in which the holding area is sheltered inside the casing and a second (“open”) configuration in which the holding area is outside the casing.

The feeding device also includes a motor operatively connected to a spool for selectively rotating the spool. A post extends adjacent the drawer and is located between the cord connection point and the front wall. A first end of a cord is coupled to the spool and a second end of the cord is coupled to the drawer at the cord connection point such that actuation of the motor moves the drawer from the closed configuration to the open configuration. A spring is operatively coupled to the drawer and casing for selectively moving the drawer from the second/open configuration to the first/closed configuration.

The pet feeding device also includes a transmitter for sending distinctive data and a sensor for receiving that distinctive data. A processor is in data communication with the sensor and the motor for actuating the motor when the sensor receives the distinctive data. The processor may also include programming for keeping the drawer in the second/open configuration for a predetermined amount of time. The transmitter may be situated in a pet collar.

Still further, the pet feeding device may include a pressure sensor in operative communication with the motor for sensing an object caught between the casing and the drawer, the pressure sensor actuating the motor upon sensing the object. Thus, the motor may be actuated to move the drawer to the open configuration if the pressure sensor senses that a pet's paw is pinched or impacted as the drawer is moving from the open configuration to the closed configuration.

Therefore, a general object of this invention is to provide a pet feeding device that presents a feeding drawer when a pet is in close proximity.

Another object of this invention is to provide a pet feeding device, as aforesaid, that automatically extends a feeding drawer when a predetermined pet is in front of or in close proximity to a predetermined feeding drawer.

Still another object of this invention is to provide a pet feeding device, as aforesaid, that automatically retracts the feeding drawer when the predetermined pet is not in front of or in close proximity to the feeding drawer, such as if the predetermined pet is nudged out of the way by another pet.

Yet another object of this invention is to provide a pet feeding device, as aforesaid, that extends the feeding drawer utilizing transmission and sensing of distinctive data, such as infrared signals.

A further object of this invention is to provide a pet feeding device, as aforesaid, that senses if an object is being pinched or impacted by a retraction of the feeding drawer and moves the feeding drawer in the open direction so as to prevent injury.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a pet feeding device according to a preferred embodiment of the present invention with a lid in an open configuration;

FIG. 1b is another perspective view of the pet feeding device as in FIG. 1a with the lid in a closed configuration;

FIG. 2 is an exploded view of the pet feeding device as in FIG. 1;

FIG. 3a is a bottom perspective view of the pet feeding device as in FIG. 1 with a portion of a bottom wall removed to show a spool and motor, the drawer being shown in a closed configuration;

FIG. 3b is another bottom perspective view as in FIG. 3a with the drawer shown in an open configuration;

FIG. 4 is another perspective view of the pet feeding device as in FIG. 1 having a scale display; and

FIG. 5 is a block diagram illustrating the electronic components of the present invention.

### DESCRIPTION OF THE PREFERRED EMBODIMENT

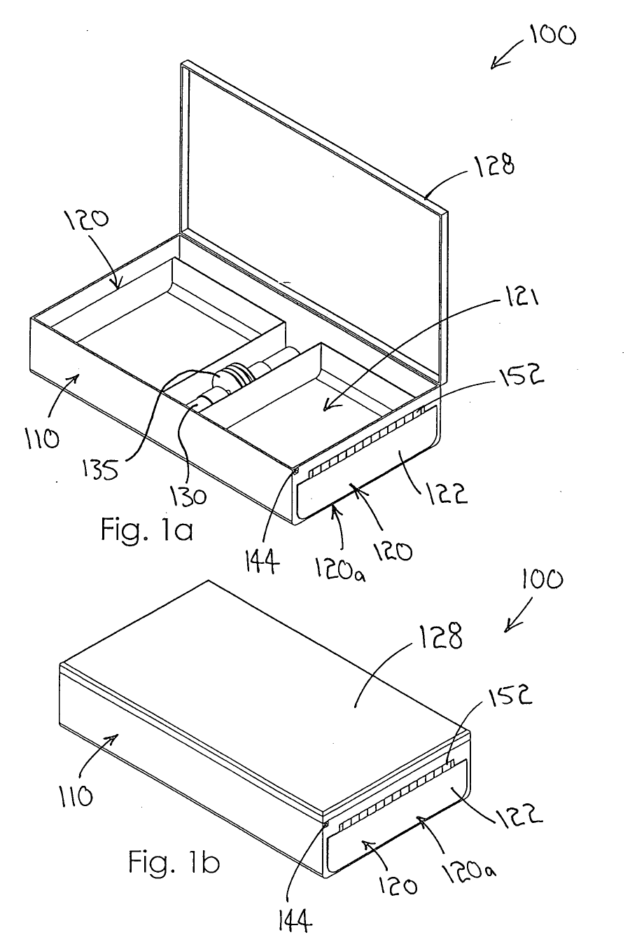

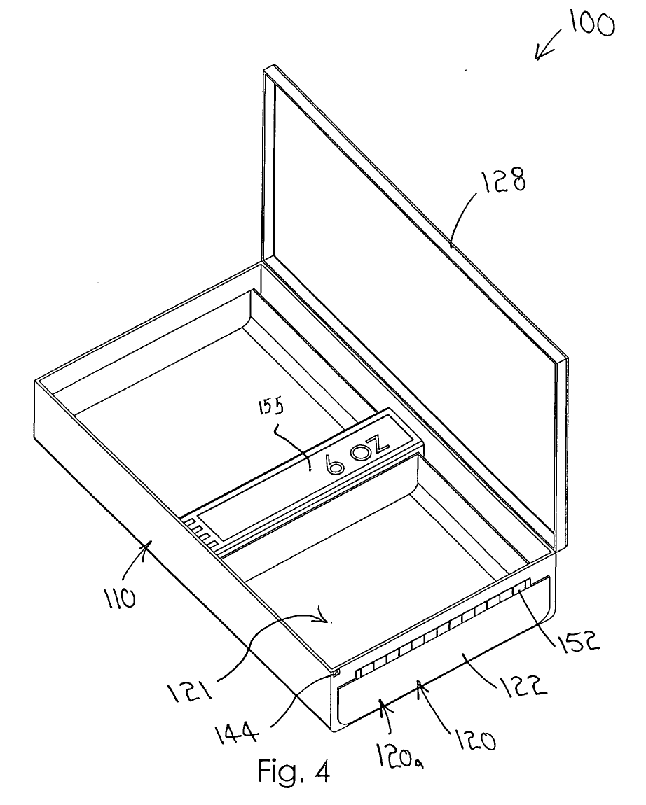

A pet feeding device (also referred to herein as a “pet feeder”) 100 according to the present invention will now be described in detail with reference to FIGS. 1a through 5 of the accompanying drawings. More particularly, a pet feeding device 100 according to the current invention includes a casing 110 and a drawer 120. Although a two-drawer unit is shown throughout the drawings, it is understood that a single drawer unit would also be suitable.

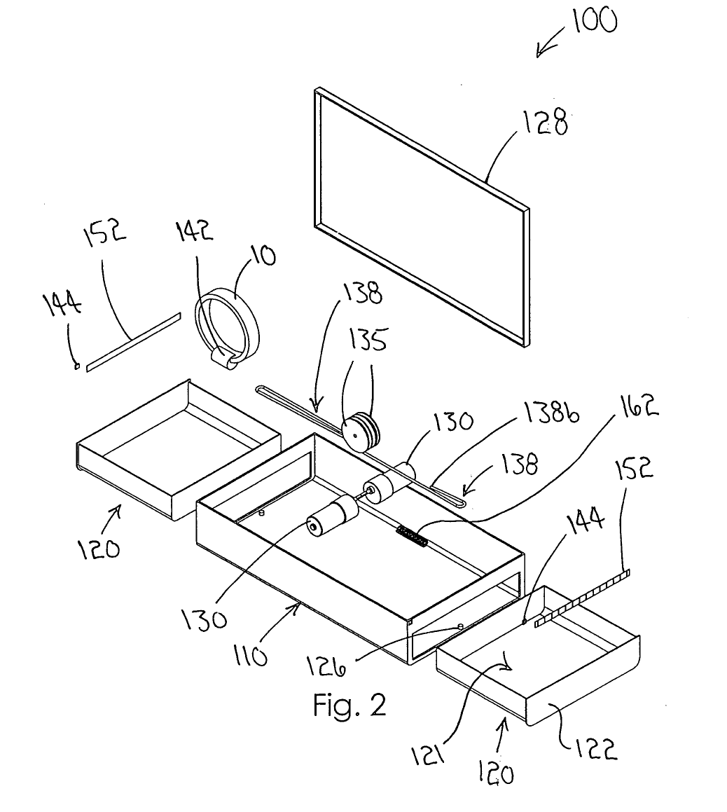

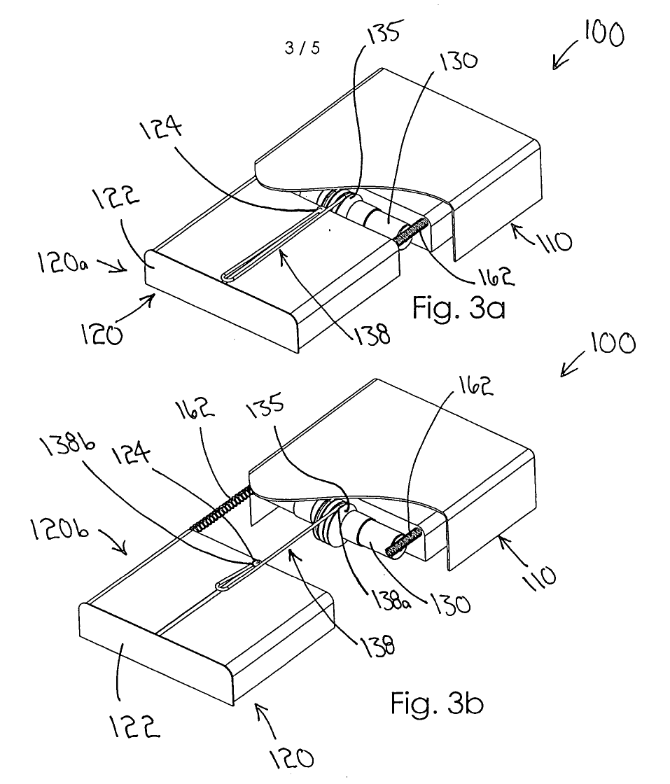

The drawer 120 has a holding area 121, a front wall 122, and a cord connection point 124, as shown in FIGS. 1a, 2, 3a, and 3b. The drawer 120 may be received (e.g., slidably received) in the casing 110 as shown throughout the drawings, and the drawer 120 may be movable between a first (also referred to herein as a “closed”) configuration 120a in which the holding area 121 is sheltered inside the casing 110 (FIGS. 1a, 1b, 3a, and 4) and a second (also referred to herein as an “open”) configuration 120b in which the holding area 121 is exposed outside the casing 110 (FIG. 3b). A post 126 may extend from the drawer 120 or from the casing 110 (FIG. 2), and the post 126 may be located between the cord connection point 124 and the front wall 122 of the drawer 120. As shown in FIGS. 1a and 1b, a lid 128 may be coupled to the casing 110, and the lid 128 may be movable to selectively allow access to the holding area 121 while the drawer 120 is at the closed configuration 120a.

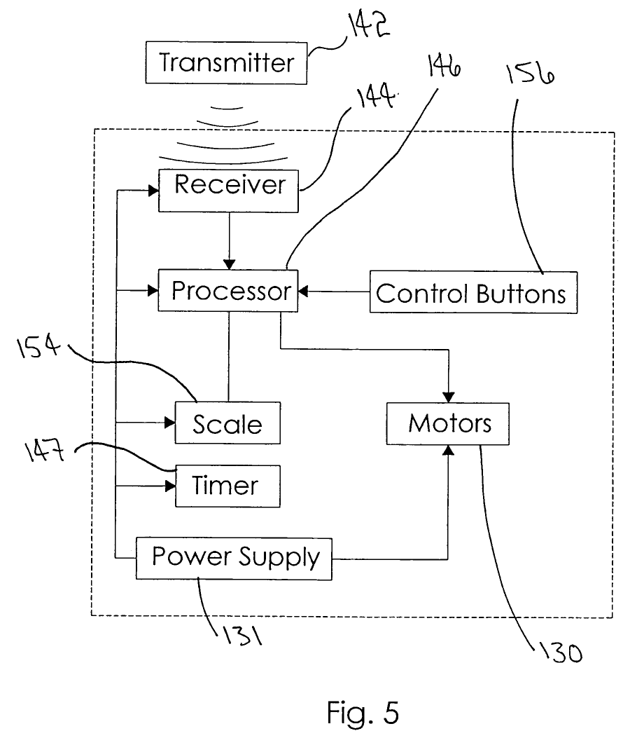

A motor 130 is operatively coupled to a spool 135 for selectively rotating the spool 135 in a first direction, and the motor 130 may additionally rotate the spool 135 in a second direction. As best shown in FIGS. 2 through 3b, a cord 138 having first and second ends 138a, 138b may be coupled to the spool 135 and the drawer 120. More particularly, the first end 138a of the cord 138 may be coupled to the spool 135, and the second end 138b of the cord 138 may be coupled to the drawer 120 at the cord connection point 124. The cord 138 may extend around the post 126 so that actuation of the motor 130 in the first direction moves the drawer 120 from the closed configuration 120a (FIG. 3a) to the open configuration 120b (FIG. 3b), and the cord 138 may be stretchable between the first and second ends 138a, 138b so that the cord 138 yields or stretches when an object is caught between the casing 110 and the drawer 120. The motor 130 may be powered by a power supply 131 (e.g., a battery or standard 110 volt AC current with adapter), as shown in FIG. 5.

Means for selectively actuating the motor 130 in the first direction may be included. More particularly, a transmitter 142 may be included for sending distinctive data, and a sensor 144 (i.e. a receiver) may be included for receiving the distinctive data (FIG. 5). The sensor 144 may be in operative communication with the motor 130 for actuating the motor 130 in the first direction when the sensor 144 receives the distinctive data. In one embodiment, for example, a processor 146 may be in data communication with the sensor 144 and the motor 130 for actuating the motor 130 when the sensor 144 receives the distinctive data, as shown in FIG. 5. The distinctive data may include modulated light and/or modulated sound, and the transmitter 142 and sensor 144 may be various types of transmitters and sensors, respectively, such as an infrared transmitter and an infrared sensor, for example. The processor 146 may include programming for maintaining the drawer 120 at the open configuration 120b for a preselected period of time after the sensor 144 receives the distinctive data; a timer 147 is shown in data communication with the processor 146 in FIG. 5. As shown in FIG. 2, the transmitter 142 may be positionable upon an animal collar 10.

A pressure sensor 152 may be in operative communication with the motor 130. As shown in FIGS. 1a and 1b, the pressure sensor 152 may be positioned adjacent the casing 110 and the front wall 122 of the drawer 120 when the drawer 120 is at the closed configuration 120a for sensing an object caught between the casing 110 and the drawer 120, e.g. a pet's paw, and actuating the motor 130 upon sensing the caught object. The pressure sensor 152 may be in data communication with the processor 146 as shown in FIG. 5, and the pressure sensor 152 may send the processor 146 caution data upon sensing an object caught between the casing 110 and the drawer 120. The processor 146 may include programming for actuating the motor 130 upon receiving the caution data so that the drawer 120 is moved toward the open configuration 120b.

As shown in FIG. 5, a scale 154 for weighing an amount of material (e.g., food) in the holding area 121 of the drawer 120 may be in data communication with the processor 146 for inputting weight data to the processor. A user input device 156 (e.g., a keypad, a dial, etc.) may be in data communication with the processor 146 for inputting control data to the processor 146 (FIG. 5), and the processor 146 may include programming for limiting actuation of the motor 130 based on the weight data and the control data. In addition, a display 155 may also be provided in the casing 110 (FIG. 1) for displaying the weight of material weighed by the scale 154.

Means for selectively moving the drawer 120 from the open configuration 120b to the closed configuration 120a may be included. More particularly, a tension member (e.g., an elastic cord or a spring 162) may be operatively coupled to the drawer 120 and the casing 110 for moving the drawer 120 from the open configuration 120b to the closed configuration 120a, or the spring 162 may be otherwise positioned and configured to move the drawer 120 through non-compression forces.

As shown throughout the drawings, multiple pet feeding devices 100 may share a single casing 110. Or, expressed differently, a single pet feeding device 100 may include multiple components discussed herein so that different pets have their own respective drawer 120 configured and functionable as described herein.

In use, the lid 128 may be moved to expose the drawer holding area 121 (FIG. 1a), pet food may be placed in the holding area 121, and the lid 128 may be replaced to restrict access to the holding area 121 while the drawer is at the closed configuration 120a (FIG. 1b). The transmitter 142 may be placed on the animal collar 10 (FIG. 2), and the collar 10 may be worn by the pet. When the transmitter 142 is near the sensor 144, the sensor 144 may directly or indirectly (e.g., through the processor 146) actuate the motor 130, causing the spool 135 to rotate and the cord 138 to be wound. Due to the cord 138 being wrapped around the post 126, the drawer 120 may be moved to the open configuration 120b. When the sensor 144 no longer receives the distinctive data from the transmitter 142, or after a predetermined amount of time as described above, the spring 162 may return the drawer 120 to the closed configuration 120a; the motor 130 may move in the second direction or be freely spinning to allow the spring 162 to return the drawer 120 to the closed configuration 120a. This situation corresponds to when the pet with the transmitter 142 moves away from the drawer 120 or is nudged away by a more aggressive pet.

As the drawer 120 may automatically close when the pet moves from the feeding device 100, the food in the holding area 121 may not be eaten by another animal. If an object (e.g., an animal paw or snout) is caught between the drawer 120 and the casing 110 while the drawer 120 is being moved to the closed configuration 120a, the pressure sensor 152 may directly or indirectly (e.g., through the processor 146) actuate the motor 130 to cause the drawer 120 to move toward the open configuration 120b so that the object may be removed without harm. The elastic nature of the cord 138 may additionally ensure that the object is not harmed if caught between the casing 110 and the drawer 120, as noted above. If the scale 154 and input device 156 are included, a user may select a predetermined amount of food that the pet may consume in a time period (e.g., a day) using the input device 156, the scale 154 may determine how much food has been consumed, and the processor 146 may restrict the drawer 120 from moving to the open configuration 120b after the predetermined amount of food has been consumed.

It is understood that while certain forms of this invention have been illustrated and described, it is not limited thereto except insofar as such limitations are included in the following claims and allowable functional equivalents thereof.

What is claimed is as follows:

1. A pet feeding device, comprising:
a casing;
a drawer having a holding area, a front wall, a cord connection point, and being slidably received in said casing, said drawer being movable between a first configuration in which said holding area is sheltered inside said casing and a second configuration in which said holding area is exposed outside said casing;
a spool;
a motor operatively coupled to said spool for selectively rotating said spool;
a post extending adjacent said drawer, said post being located between said cord connection point and said front wall;
a cord having first and second ends, said cord first end being coupled to said spool, said cord second end being coupled to said drawer at said cord connection point, said cord extending around said post, wherein actuation of said motor moves said drawer from said first configuration to said second configuration;
means for selectively moving said drawer from said second configuration to said first configuration; and
means for selectively actuating said motor.

2. The pet feeding device of claim 1, wherein said cord is stretchable between said first and second ends.

3. The pet feeding device of claim 1, further comprising a lid coupled to said casing, said lid being movable to selectively allow access to said holding area while said drawer is at said first configuration.

4. The pet feeding device of claim 1, wherein said means for selectively moving said drawer from said second configuration to said first configuration includes a spring operatively coupled to said drawer and said casing.

5. The pet feeding device of claim 1, wherein said means for selectively actuating said motor includes:
a transmitter for sending distinctive data;
a sensor for receiving said distinctive data; and
a processor in data communication with said sensor and said motor for actuating said motor when said sensor receives said distinctive data.

6. The pet feeding device of claim 5, wherein:
said transmitter is an infrared transmitter; and
said sensor is an infrared sensor.

7. The pet feeding device of claim 6, wherein said processor includes programming for maintaining said drawer at said second configuration for a preselected period of time after said sensor receives said data.

8. The pet feeding device of claim 5, wherein said distinctive data is selected from the group consisting of modulated light and modulated sound.

9. The pet feeding device of claim 5, wherein said transmitter is positionable upon an animal collar.

10. The pet feeding device of claim 5, further comprising:
a scale for weighing an amount of material in said holding area of said drawer, said scale being in data communication with said processor for inputting weight data to said processor;
a user input device in data communication with said processor for inputting control data to said processor; and
programming in said processor for limiting actuation of said motor based on said weight data and said control data.

11. The pet feeding device of claim 5, further comprising:
a pressure sensor in data communication with said processor, said pressure sensor being adjacent said casing and said front wall of said drawer when said drawer is at said first configuration for sensing an object caught between said casing and said drawer and sending said processor caution data; and
programming in said processor for actuating said motor upon receipt of said caution data.

12. The pet feeding device of claim 1, wherein said means for selectively actuating said motor includes:
a transmitter for sending distinctive data; and
a sensor for receiving said distinctive data, said sensor being in operative communication with said motor for actuating said motor when said sensor receives said distinctive data.

13. The pet feeding device of claim 12, further comprising a pressure sensor in operative communication with said motor, said pressure sensor being adjacent said casing and said front wall of said drawer when said drawer is at said first configuration for sensing an object caught between said casing and said drawer and actuating said motor upon sensing said object.

14. A pet feeder, comprising:
a casing;
a drawer having a holding area, a front wall, a cord connection point, and being received in said casing, said drawer being movable between a closed configuration in which said holding area is sheltered inside said casing and an open configuration in which said holding area is exposed outside said casing;
a spool;
a motor operatively coupled to said spool for selectively rotating said spool in first and second directions;
a post extending from an item selected from the group consisting of said drawer and said casing, said post being located between said cord connection point and said front wall of said drawer;
a cord having first and second ends, said cord first end being coupled to said spool, said cord second end being coupled to said drawer at said cord connection point, said cord extending around said post, wherein actuation of said motor in said first direction moves said drawer from said closed configuration to said open configuration;
means for selectively moving said drawer from said open configuration to said closed configuration; and
means for selectively actuating said motor in said first direction.

15. The pet feeder of claim 14, wherein said means for selectively moving said drawer from said open configuration to said closed configuration includes a tension member operatively coupled to said drawer and said casing.

16. The pet feeder of claim 14, wherein said means for selectively actuating said motor in said first direction includes:
a transmitter for sending distinctive data, said transmitter being positionable upon an animal collar; and
a sensor for receiving said distinctive data, said sensor being in operative communication with said motor for actuating said motor in said first direction when said sensor receives said distinctive data.

17. The pet feeder of claim 16, further comprising a pressure sensor positioned to sense an object caught between said casing and said drawer, said pressure sensor being in operative communication with said motor to actuate said motor in said first direction upon sensing said object caught between said casing and said drawer.

18. The pet feeder of claim 17, wherein said cord is stretchable between said first and second ends, whereby said cord yields when said object is caught between said casing and said drawer.

19. The pet feeder of claim 14, wherein:
said means for selectively actuating said motor in said first direction includes:
a transmitter for sending distinctive data, said transmitter being positionable upon an animal collar;
a sensor for receiving said distinctive data;
a processor in data communication with said sensor and said motor for actuating said motor in said first direction when said sensor receives said distinctive data;
said distinctive data is selected from the group consisting of modulated light and modulated sound; and
said cord is stretchable between said first and second ends, whereby said cord yields when an object is caught between said casing and said drawer.

20. A pet feeder, comprising:
a casing;
a plurality of drawers, each said drawer having a holding area, a front wall, a cord connection point, and being slidably received in said casing, each said drawer being movable between a closed configuration in which said respective holding area is sheltered inside said casing and an open configuration in which said respective holding area is exposed outside said casing;
a plurality of spools;
a plurality of motors, each said motor being operatively coupled to a respective spool for selectively rotating said respective spool;
a respective post adjacent each said drawer between a respective cord connection point and a respective front wall;
a plurality of cords, each said cord having a first end coupled to a respective spool and a second end coupled to a respective drawer at a respective cord connection point, each respective cord extending around a respective post, wherein actuation of a respective motor moves a respective drawer from said closed configuration to said open configuration;
means for selectively moving each said drawer from said open configuration to said closed configuration; and
means for selectively actuating each said motor.
